(19) United States
(12) Patent Application Publication
(10) Pub. No.: US 2013/0032018 A1
(43) Pub. Date: Feb. 7, 2013

(54) SAW BLADE

(71) Applicants: CHAO-JEN CHANG, TAICHUNG CITY (TW); SHI-GUI GU, KAOHSIUNG CITY (TW)

(72) Inventors: CHAO-JEN CHANG, TAICHUNG CITY (TW); SHI-GUI GU, KAOHSIUNG CITY (TW)

(73) Assignee: KUANG YUNG MACHINERY CO., LTD., TAICHUNG CITY (TW)

(21) Appl. No.: 13/308,529

(22) Filed: Nov. 30, 2011

(30) Foreign Application Priority Data
Aug. 1, 2011 (TW) 100214120

(51) Int. Cl. B23D 61/02

(52) U.S. Cl. 83/835

(57) ABSTRACT

A saw blade includes a circular body having teeth defined in the outer periphery thereof and a central hole is defined through the center of the circular body. The circular body has an inner annular area and an outer annular area, the inner annular area extends radially outward from the central hole to a radial distance of the circular body and the outer annular area extends from the outer periphery of the inner annular area to the outer periphery of the circular body. The outer annular area is narrower than the inner annular area, the outer annular area is thinner than the inner annular area, and the teeth are thicker than the outer annular area. The thinner outer annular area does not contact the object to bet cut. The wider inner annular area supports the narrower outer annular area.

### BACKGROUND OF THE INVENTION

(1) Field of the Invention

The present invention relates to a circular saw blade, and more particularly, to a circular saw blade wherein with wider and thicker inner annular area to efficiently cut objects.

(2) Description of the Prior Art

A conventional saw blade, for cutting wood, stones, tiles or metal is shown in FIGS. 1 and 2, and generally includes a circular body 10 and multiple inclined teeth are defined along the outer periphery of the circular body 10. A central hole 12 is defined through the center of the circular body 10. The thickness of the circular body 10 of the saw blade 10 is even and identical and the thickness of the teeth 11 is different from that of the circular body 10. When the saw blade is activated by the motor, because the thickness of the circular body 10 of the saw blade 10 is even and identical, a significant resistance and heat are generated, therefore, the cutting speed is slow and a lot of material of the object to be cut is wasted.

Accordingly, the conventional saw blade has the following shortcomings:

1. The resistance is significant.

2. The cutting speed is slow.

3. Too much material of the object 13 to be cut is wasted during cutting.

4. A high horse power motor is needed and requires significant electric power.

5. Too much noise is generated.

An improved saw blade is developed as shown in FIGS. 3 and 4, and comprises a circular body 20 with multiple teeth 21 on the periphery thereof and a central hole 22 is defined through the center of the circular body 20. The thickness of the circular body 20 is not even and identical and the circular body 20 has an inner annular area 23 which extends from the central hole 22 to a radial distance, and an outer annular area 24 which extends from the outer periphery of the inner annular area 23 to the periphery of the circular body 20. The inner annular area 23 and the conventional circular body of the conventional saw blade has the same thickness, and the thickness of the outer annular area 24 is less than that of the inner annular area 23. A radial width of the outer annular area 24 is substantially the same as that of the inner annular area 23. As shown in FIG. 5, the thickness of the teeth 21 is “X” and the thickness of the outer annular area 24 is “Y”. When the saw blade is in operation, the resistance is reduced because the thickness of the outer annular area 24 is less than that of the inner annular area 23, and the material that is wasted from the object 25 to be cut is reduced. However, the thickness of the outer annular area 24 is not thick enough, the saw blade cannot cut straight and cut along a curve line 26. In addition, the high temperature is easily conducted to the outer annular area 24 and damages the outer annular area 24.

Assume that diameter of the circular body 20 of the saw blade is 300 mm, the thickness of the inner annular area 23 is 2.2 mm and the thickness of the outer annular area 24 is 1.6 mm (Y), and the thickness of the teeth 21 is 2.2 mm (X). When cutting a wood block, the teeth 21 cut the wood block first and then the outer annular area 24 enters into the wood block. Assume that a gap “Z” is defined between the outer annular area 24 and the wood block after being cut, the gap “Z” is so small that the outer annular area 24 is almost in contact with the wood block. The circular body 20 rotates at high speed and the outer annular area 24 generates high temperature.

The outer annular area 24 is almost in contact with the wood block so that the outer annular area 24 generates high temperature which can damage the outer annular area 24. The widths of the inner and outer annular areas 23, 24 are the same so that the inner annular area 23 cannot support the impact to the outer annular area 24 so that the outer annular area 24 is deformed. The saw blade cannot cut straight and may cut along a curved line 26. The life of the saw blade is shortened and high resistance and noise are generated.

The present invention intends to provide a saw blade which improves the shortcomings of the conventional saw blades.

### SUMMARY OF THE INVENTION

The present invention relates to a saw blade and comprises a circular body having teeth on the outer periphery thereof and each tooth is an inclined blade. A central hole is defined through the center of the circular body. The circular body has an inner annular area and an outer annular area, the inner annular area extends from the central hole to a radial distance, and the outer annular area extends from the outer periphery of the inner annular area to the outer periphery of the circular body. The width of the outer annular area is smaller than the width of the inner annular area. The thickness of the outer annular area is smaller than the thickness of the inner annular area.

The thickness of the teeth is larger than the thickness of the outer annular area so that the outer annular area is separated from an object to bet cut. The width of the outer annular area is smaller than that of the inner annular area so that the outer annular area is well supported and the saw blade does not generate high temperature and has small resistance and low noise.

The primary object of the present invention is to provide a saw blade that can be operated at high speed while the resistance, temperature and noise are reduced.

Another object of the present invention is to provide a saw blade that cuts straight and saves the material of the object to be cut.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a conventional saw blade;

FIG. 2 shows that the conventional saw blade is cutting an object;

FIG. 3 shows another conventional saw blade;

FIG. 4 shows that the conventional saw blade in FIG. 3 is cutting an object;

FIG. 5 is a cross sectional view to show that the conventional saw blade in FIG. 3 is cutting an object;

FIG. 6 is a cross sectional view of the saw blade of the present invention;

FIG. 7 shows that the saw blade of the present invention is cutting an object, and

FIG. 8 shows a cross sectional view to show that the saw blade of the present invention is cutting the object.

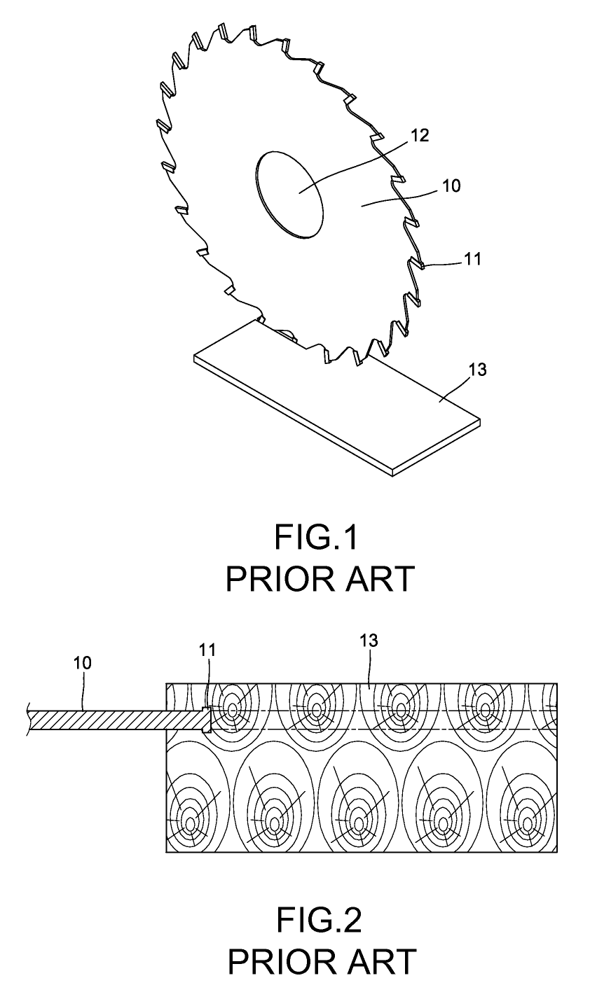

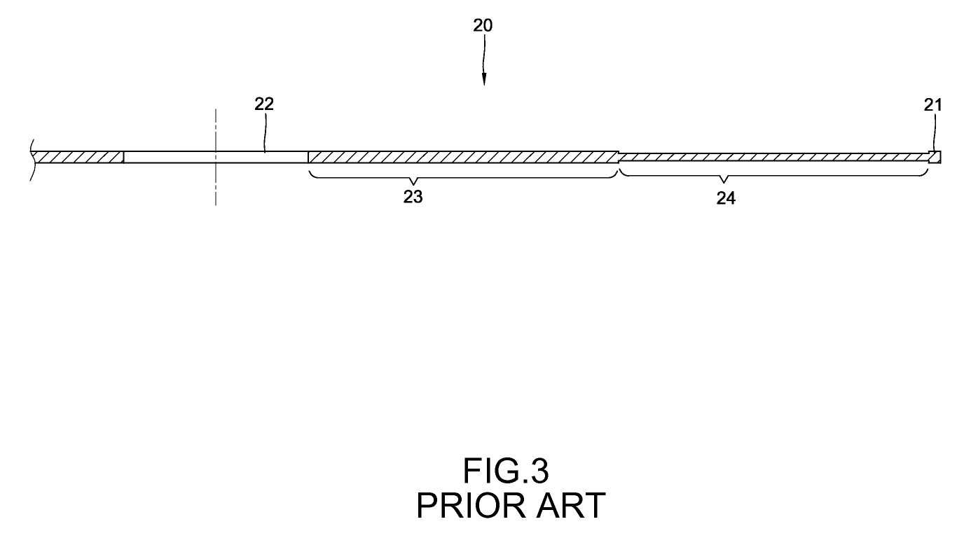

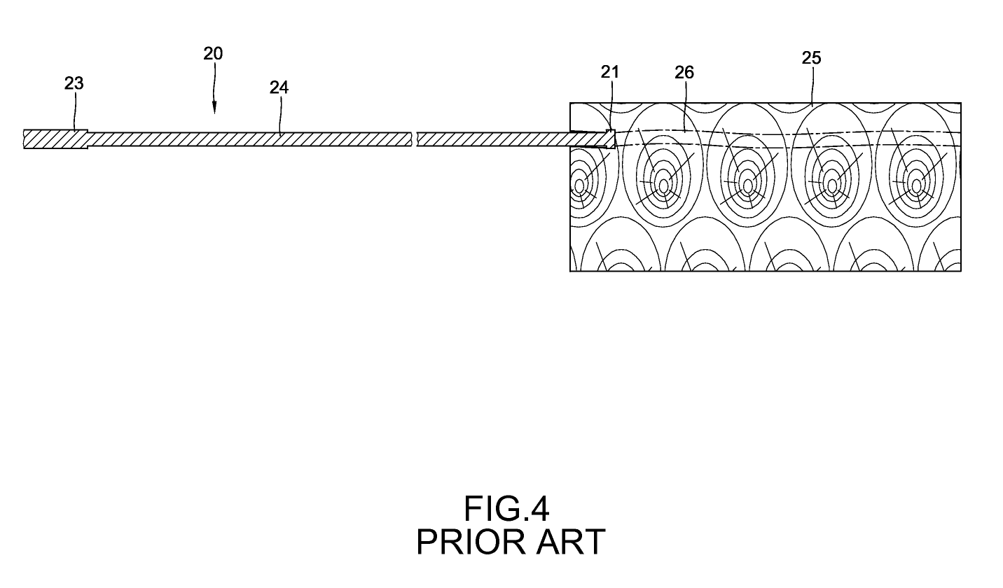

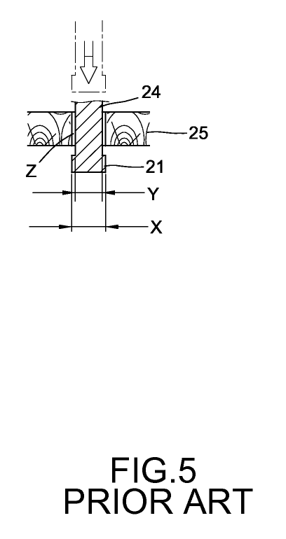

### DETAILED DESCRIPTION OF THE PREFERRED EMBODIMENTS

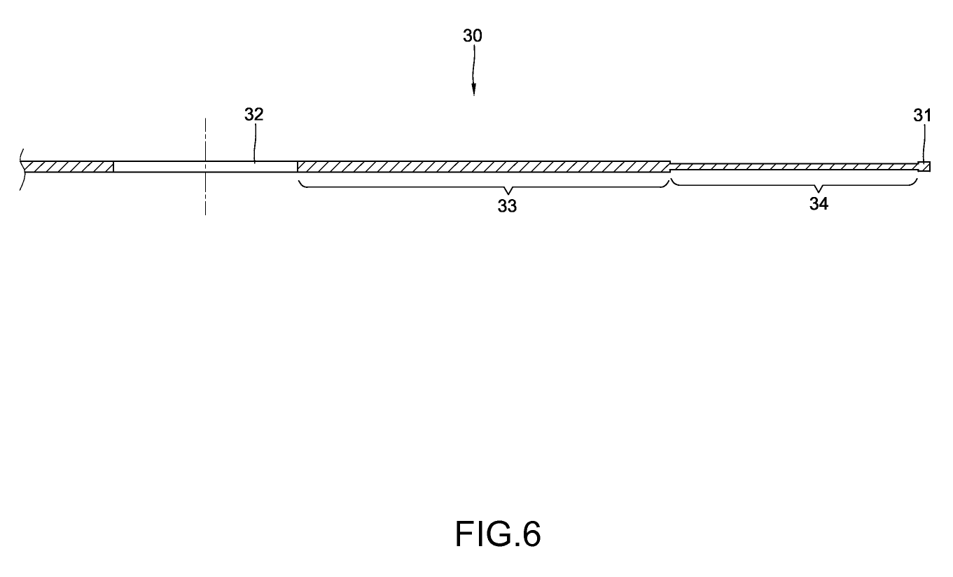

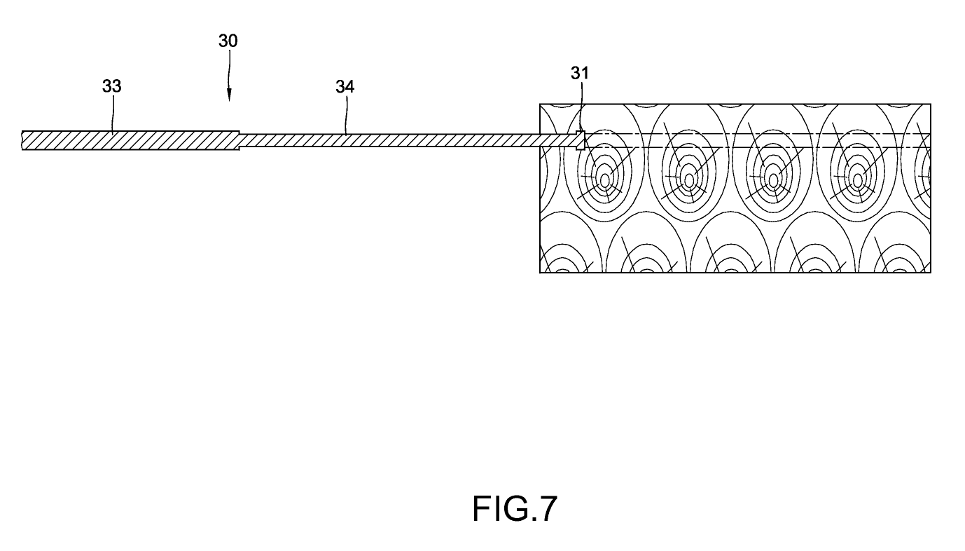

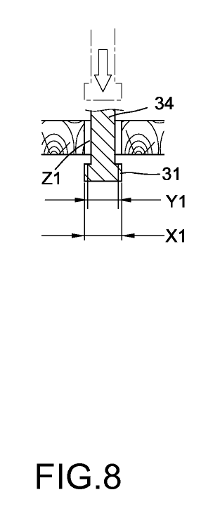

Referring to FIGS. 6 to 8, the saw blade of the present invention comprises a circular body 30 having teeth 31 defined in the outer periphery thereof and a central hole 32 defined through the center of the circular body 30 so that the shaft (not shown) is securely engaged with the central hole 32. Each tooth 31 is an inclined blade and the number of the teeth 31 can be 50. The circular body 30 has an inner annular area 33 and an outer annular area 34, wherein the inner annular area 33 extends radially and outward from the central hole 22 to a radial distance of the circular body 30, the outer annular area 34 extends from the outer periphery of the inner annular area 23 to the outer periphery of the circular body 30. The width of the outer annular area 34 is smaller than the width of the inner annular area 33. The thickness of the outer annular area 34 is smaller than the thickness of the inner annular area 33. The thickness of the teeth 31 is larger than the thickness of the outer annular area 34. The width of the inner annular area 33 is more than 1.5 times of the width of the outer annular area 34. The thickness of the outer annular area 34 is smaller than ⅗ of the thickness of the inner annular area 33. The thickness of the outer annular area 34 is smaller than ⅔ of the thickness of the teeth 31.

Assume that the diameter of the circular body 30 is 300 mm, the thickness of the inner annular area 33 is 2.6 mm and the thickness of the outer annular area 34 is 1.3 mm to 1.4 mm (Y1), and the thickness of the teeth 31 is 2.2 mm (X1). When cutting a wood block, the teeth 31 cut the wood block first and then the outer annular area 34 enters into the wood block. Assume that a gap “Z1” is defined between the outer annular outer annular area 34 and the wood block after being cut. The gap “Z1” is large enough so that the outer annular area 34 does not in contact with the wood block. The circular body 30 rotates at high speed and the outer annular area 34 does not generate high temperature.

The thickness of the inner annular area 33 is 2.6 mm and the thickness of the outer annular area 34 is 1.3 mm to 1.4 mm (Y1), so that the width of the outer annular area 34 is smaller than that of the inner annular area 33 so that the outer annular area 34 is well supported to ensure that the saw blade does not deform. In addition, the thickness of the outer annular area 34 is thinner than that of the conventional saw blades, and the thickness of the teeth 31 is larger than that of the outer annular area 34, so that the outer annular area 34 does not in contact with the wood block. The circular body 30 rotates at high speed and the outer annular area 34 does not generate high temperature.

When cutting hard wood, such as oak of 30 mm thickness, the feeding speed can reach to 60 m/min. The saw blade is stable when the teeth 31 first cut the wood and the saw blade cuts straight.

There are advantages for the saw blade of the present invention:

1. The width of the inner annular area 33 is more than 1.5 times of the width of the outer annular area 34 so that the outer annular area 34 is well supported and the saw blade is not damaged when cutting at high speed.

2. The thickness of the teeth 31 is thicker than that of the outer annular area 34 so that the gap “Z1” between the outer annular outer annular area 34 and the wood block after being cut is large enough and the outer annular area 34 does not in contact with the wood block. The outer annular area 34 does not generate high temperature.

3. The resistance is reduced so that the feeding speed can be increased and the feeding speed of the present invention can be two times of that for the conventional saw blades. The noise is also reduced for the saw blade of the present invention.

4. The saw blade of the present invention can cut straight and does not have curved cutting faces.

5. The saw blade of the present invention saves the objects to be cut.

6. The saw blade of the present invention has longer life of use.

While we have shown and described the embodiment in accordance with the present invention, it should be clear to those skilled in the art that further embodiments may be made without departing from the scope of the present invention.

What is claimed is:

1. A saw blade comprising:
a circular body having teeth defined in an outer periphery thereof and each tooth being an inclined blade, a central hole defined through a center of the circular body, the circular body having an inner annular area and an outer annular area, the inner annular area extending radially outward from the central hole to a radial distance of the circular body, the outer annular area extending from an outer periphery of the inner annular area to the outer periphery of the circular body, a width of the outer annular area being smaller than a width of the inner annular area, a thickness of the outer annular area being smaller than a thickness of the inner annular area, a thickness of the teeth being larger than the thickness of the outer annular area, the outer annular area being separated from an object to bet cut.

2. The saw blade as claimed in claim 1, wherein the width of the inner annular area is more than 1.5 times of the width of the outer annular area.

3. The saw blade as claimed in claim 1, wherein the thickness of the outer annular area is smaller than ⅗ of the thickness of the inner annular area.

4. The saw blade as claimed in claim 1, wherein the thickness of the outer annular area is smaller than ⅔ of the thickness of the teeth.
